(19) United States
(12) Patent Application Publication
(10) Pub. No.: US 2014/0251848 A1
(43) Pub. Date: Sep. 11, 2014

(54) Device and method for storage of collectible cards

(71) Applicant: Ultra Pro International, LLC, Commerce, CA (US)

(72) Inventor: Sonia Neill, Bloomington, CA (US)

(73) Assignee: Ultra Pro International, LLC, Commerce, CA (US)

(21) Appl. No.: 14/198,863

(22) Filed: Mar. 6, 2014

Related U.S. Application Data
(60) Provisional application No. 61/776,150, filed on Mar. 11, 2013.

(51) Int. Cl. B42F 17/00; B65D 5/42; B31B 1/90; B31B 1/25; B31B 1/66; B65D 5/66; B31B 1/20

(52) U.S. Cl. CPC B42F 17/00; B65D 5/6679; B65D 5/4204; B31B 1/20; B31B 1/25; B31B 1/66; B31B 1/90
USPC 206/425; 229/138; 229/162.1; 229/198.3; 493/59; 493/162; 493/222

(57) ABSTRACT

The invention is directed toward a unique self-locking storage device for collectable cards. The container has an upper member and a lower member which are hingedly connected by a back panel. The upper member of the container fully encloses the lower member of the container when the container is closed. The panels of the upper member of the container present an uninterrupted view of decorative artwork when the container is closed. The container is preferably constructed of an acid-free poly propylene to allow protection of the collectable cards.

### PRIORITY

This application claims the benefit of U.S. Provisional Application No. 61776150, filed 11 Mar. 2013.

### FIELD OF INVENTION

The invention relates generally to collectible card holders. More specifically the invention is directed to a self-locking container with an uninterrupted view of the artwork on the front, top and side panels.

### BACKGROUND OF INVENTION

Collectible cards are small cards which depict images of popular games, people, comic book characters, and many other variations. Baseball cards are a type of collectible card widely recognized in the public domain. The handling and storage of collectible cards is very important to protect the integrity of the cards. When cards are handled and shuffled with other cards, breakdown, such as wearing, fraying, and discoloration of the card occurs. Therefore, collectors have typically utilized containers to store collectible cards and protect their integrity.

Early on, card collections were maintained in various types of cardboard containers, including cigar containers, shoe containers, or check containers. The use of these types of cardboard containers failed to fully protect the cards because the containers easily compressed, allowing outside forces to damage the cards. The containers were also manufactured and held together with various industrial glues. The chemicals in the glues had the ability to cause damage to the collectible cards.

Later on, plastic containers or sleeves were utilized to store the collectible cards. These types of containment devices were often constructed out of a transparent material which allowed a collector to view the cards. However, the transparency of the material allowed sunlight and other ultraviolet light to pass through, which had the potential to damage the card. Plastic sleeves provided further limitations as well. First, the sleeves were difficult and expensive to use because only one card could be stored in the sleeve, requiring several sleeves to accommodate large collections. Second, additional time was required to store individual cards in the sleeves than when storing multiple cards in one container. Finally, plastic sleeves were typically manufactured from polyvinylchloride (PVC) which carried the potential to create an acid that yellowed and deteriorated the cards.

In recent years, there have been several other attempts to improve storage containers, including manufacturing the containers out of translucent or opaque materials to prevent light from passing through and damaging the cards. These types of containers are formed out of single flat blanks which are cut to a specific shape, allowing the blank to fold and connect to itself, forming a container with a lid. However, many of these containers require the outer lid panel to be held to the inner panel through a nonpermanent attaching means, such as hook and loop tape, or an elastic band which wraps around the entire container. These types of containers can also be manufactured with artwork on the outside of the container which serves to decorate to the container and inform the collector about the card contents of the container. For instance, external artwork showing a baseball image would inform a collector the container contained baseball cards.

While lids held down by hook and loop tape do allow for an uninterrupted view of the artwork on the container, the lids are not secure when closed, resulting in the hook and loop tape becoming frayed and ineffective over time due to repeated operations. Other containers with fold down tops do not have this issue; however, the fold down top interrupts the view of the artwork displayed on the container. When a container with a fold down top is closed, a horizontal line running across the image results. This line interrupts the viewing experience and disrupts a collector's enjoyment of the artwork on the container. What is needed is a container with a fold down top which is self locking when closed, but does not interrupt the viewing of the exterior artwork on the container.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

To resolve the problems mentioned above, the invention is directed towards a container for storing and protecting collectible cards formed from a single blank of material, the container being of parallelepiped shape, and having an outer member and an inner member. The outer member folds over the inner member to form a covered container. The outer member comprising a top panel, a front panel, two opposing side panels, a back panel, and a means for securing the opposing side panels to the front panel and the back panel. The front panel, back panel, and opposing side panels fold downward along the lateral edges of the top panel. The inner member comprising a flat base, an inner front panel, two opposing side panels, the back panel, and a means for securing the opposing side panels to the inner front panel and the back panel. The inner front panel, opposing side panels, and back panel fold upwards along the lateral edges of the flat base. The outer member and inner member share a hinge connection located on the back panel. The frictional fit resulting from the hinge connection and the outer member encompassing the inner member results in a self-locking container. The outer member front panel and opposing side panels of the outer member surround the inner panel and opposing side panels of the inner member. This allows for an uninterrupted, seamless view of the entire outer member when the outer member is closed over the inner member so that artwork may be displayed on all sides of the container without seams or other interruption.

In another embodiment the securing means on the outer member and inner member comprise a first and second set of connection mechanisms on each member. The first set of connection mechanisms on the outer member comprising a first securing tab and a second securing tab located on the first opposing side panel. The first securing tab secures to the top panel, the second securing tab secures to the back panel. The second set of connection mechanisms on the outer member comprise a first securing tab and a second securing tab located on the second opposing side panel. The first securing tab secures to the top panel, the second securing tab secures to the back panel, the first set of connection mechanisms on the inner member comprising a first securing tab and a second securing tab located on the first opposing side panel. The first securing tab secures to the base panel. The second securing tab secures to the back panel. The second set of connection mechanisms on the inner member comprise a first securing tab and a second securing tab located on the second opposing side panel. The first securing tab secures to the base panel, the second securing tab secures to the back panel.

In another embodiment of the present invention, the connection mechanisms of the container may be secured to the respective locations on the container by fusing. It is further envisioned that the fusing of the connection mechanisms on the outer opposing side panels and the inner opposing side panels may be accomplished through ultrasonic welding.

In another embodiment of the present invention the hinge connection located on the back panel of the container, is created by an upper score and a lower score across the back panel.

In another embodiment of the present invention, the back panel on the storage container is approximately 3.75 inches in width and approximately 2.81 inches in height. The outer member front panel on the storage container is approximately 3.87 inches in width, and approximately 2.77 inches in height. The inner panel on the inner member of the storage container is approximately 3.75 inches in width, and approximately 2.16 inches in height at the lowest point of the inner panel. It is further envisioned that the upper and lower scores located on the back panel of the container may also be located approximately 0.73 inches apart from each other. It is further envisioned that the upper score may be located at a distance of approximately 0.71 inches below the top of the back panel.

In another embodiment of the present invention the blank material which forms the container may be comprised of a thermoplastic polymer. The thermoplastic polymer material may further include polypropylene, polystyrene, or acid-free polypropylene.

The invention is also directed to a method for creating a container for storing and protecting collectible cards, the method comprising: cutting a blank of material to a foldable shape with foldable members, scoring the blank in two locations on a back panel to create a hinge connection, folding the blank into a container, and securing the foldable members together.

In another embodiment, the method for creating a container may utilize fusing to secure the foldable members to the container. The fusing of the foldable members may further be accomplished by ultrasonic welding.

In another embodiment, the method for creating a container may also utilize a thermoplastic polymer as the blank material. It is further envisioned that the type of thermoplastic polymer used in the method for creating a container may include polypropylene, polystyrene, or acid free polypropylene.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of the collectible card holder from the left perspective in accordance with the invention.

FIG. 2 is a rear right perspective view of the collectible card holder.

FIG. 3 is a similar three dimensional view of the collectable card holder from the right perspective.

FIG. 4 is a three-dimensional view of the collectible card holder of FIG. 1 depicting the attachment locations of the securing tabs.

FIG. 5 is a plan view of the one-piece blank of material which is suitably cut and provided with fold lines to form the container of this invention when folded, and secured.

FIG. 6 is a perspective view of the blank shown in one embodiment utilizing particular dimensions.

FIG. 7 is a perspective view of the blank of FIG. 6 as it is partially folded.

FIG. 8 is a perspective view, similar to FIG. 7, showing a subsequent folding stage.

FIG. 9 is a perspective view, similar to FIG. 8, showing a subsequent folding stage.

### DESCRIPTION

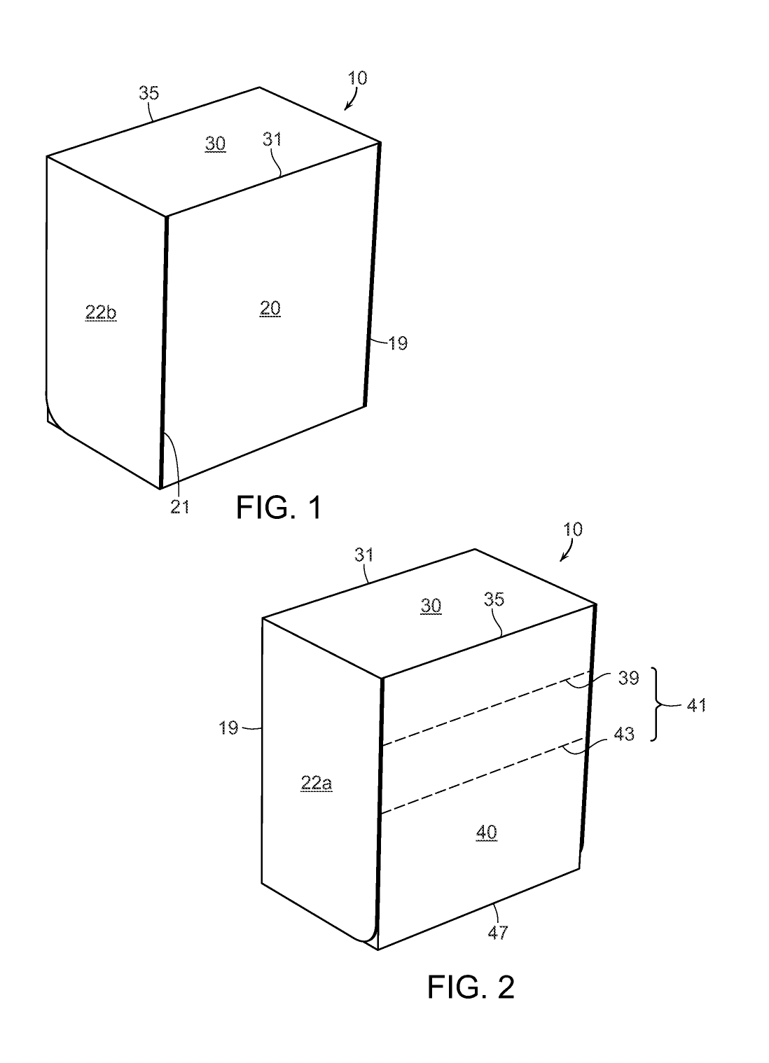

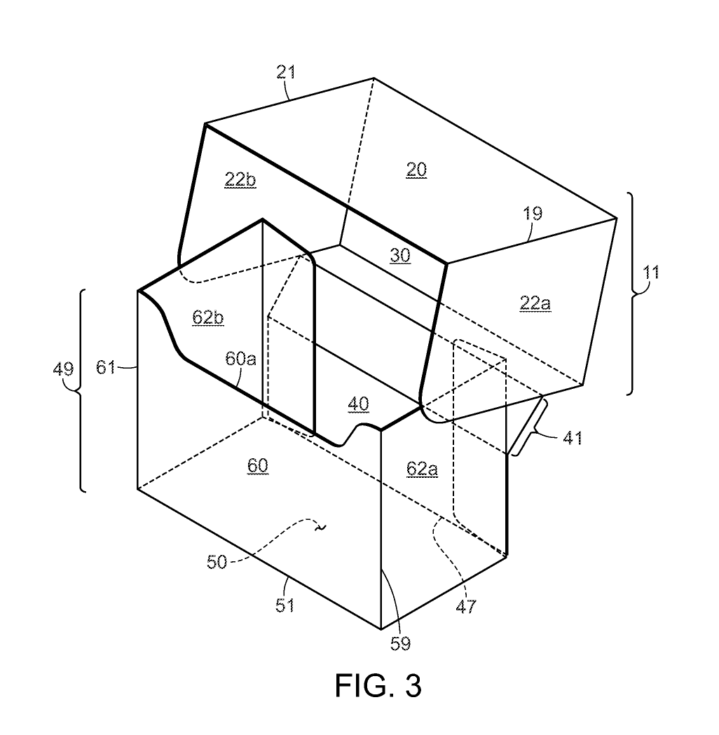

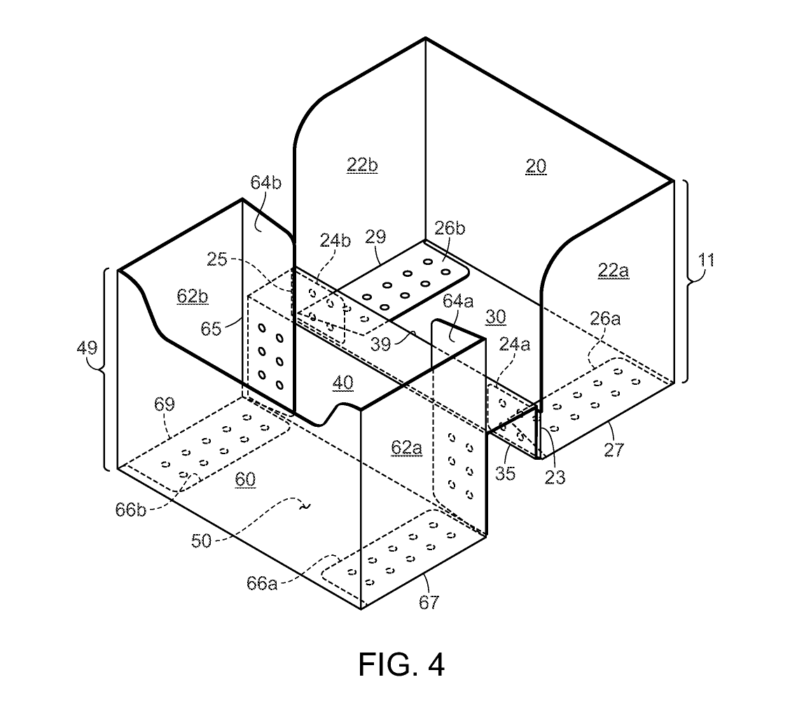

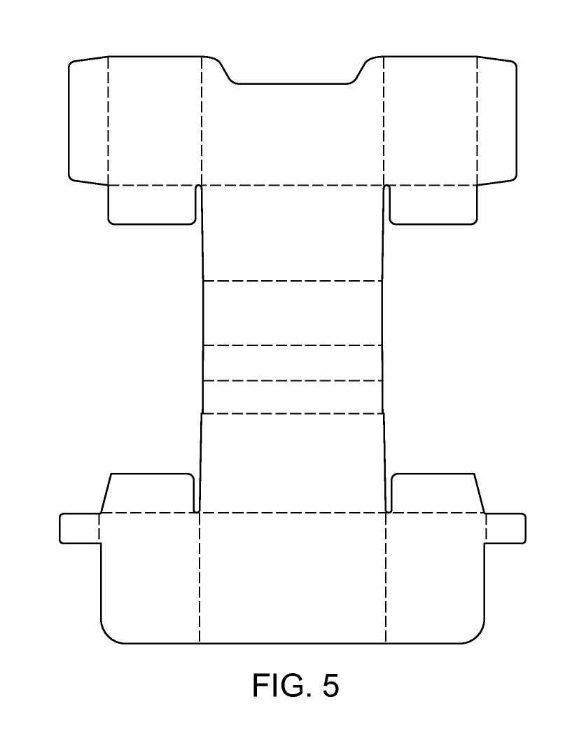

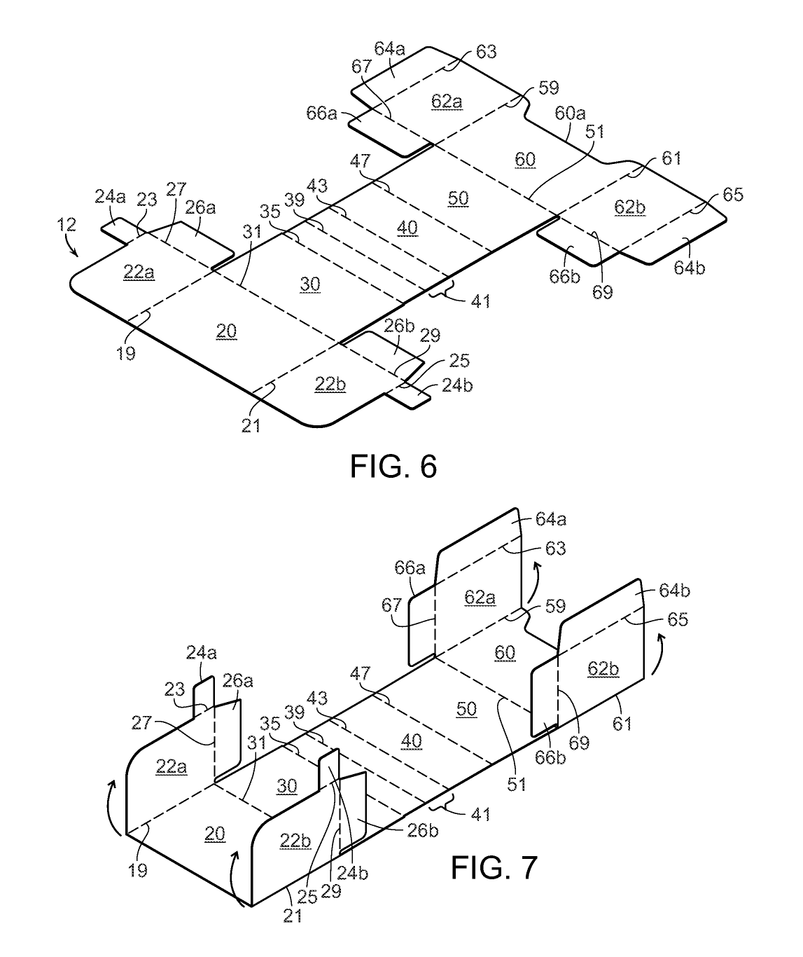

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims. Referring now to the drawings in detail, wherein like numerals indicate like elements throughout the several views, FIGS. 1 and 2 depict a one-piece, self-locking collectible card holder embodying the present invention. FIG. 3 is a similar three dimensional view of the collectable card holder from the right perspective. FIG. 4 is a three-dimensional view of the collectible card holder of FIG. 1 with the outer member of the container open in preparation for receiving cards from the top loading position. FIG. 5 is a plan view of the one-piece blank of material which is suitably cut and provided with fold lines to form the container of this invention when folded, and secured. FIG. 6 is a perspective view of the blank shown in one embodiment utilizing particular dimensions. FIGS. 7-9 are similar perspective views of the blank of FIG. 5 showing subsequent folding stages.

FIG. 1 depicts a perspective view of the container 10 with the outer member 11 closed over the inner member 49. The container 10 is comprised of an outer member 11, and an inner member 49 which close to form the container 10. The outer member 11 has a top panel 30, a front panel 20, two opposing side panels (22a and 22b), and a back panel 40 all of which are folded downwardly at a 90 degree angle along the lateral edges of the top panel 30. The top panel 30 and front panel 20 share a horizontal fold line 31. The top panel 30 and the back panel 40 share a horizontal fold line 35. The back panel 40 is shared by the outer member 11 and inner member 49. The outer member 11 has two opposing side panels (22a and 22b) which extend from the front panel 20 on the right and left side. The opposing side panels (22a and 22b) fold along vertical fold lines (19 and 21) at a 90 degree angle away from the front panel 20. The outer member left panel 22b shares vertical fold line 21 with the front panel 20. The outer member right panel 22a shares vertical fold line 19 with the front panel 20. The outer member 11 includes securing means for securing the opposing side panels (22a and 22b) to the front panel 20 and back panel 40. When the outer member 11 is closed over the inner member 49, the front panel 20, opposing side panels (22a and 22b), and top panel 30, show such that artwork may be displayed on any or all of the panels on the outer member 11 in an uninterrupted view, thus allowing artwork printed on the outer member to be uninterrupted for improved optics.

The design of the container 10, allows the front panel 20 and opposing side panels (22a and 22b) of outer member 11 to completely encompass the inner front panel 60, and opposing side panels (62a and 62b) of the inner member 49 so that artwork may be displayed on the front and sides of the container without seams or other visual interruptions. Super heroes, athletic graphics depicting players or scenes, comic book characters, animated cartoon characters and any other type of artwork now known or later discovered may be reproduced on the outer member 11 for the purpose of informing the viewer about the internal contents of the container 10.

FIG. 2 depicts the rear view of the container 10 in the closed position. When closed, the outer member 11 completely encompasses the inner panel 60 and opposing side panels (62a and 62b) of the inner member 49. The outer member 11 and inner member 49 are hingedly connected on the back panel 40 of the container. An upper score 39 and a lower score 43 created in the back panel 40 create hinge 41. The scores may be formed by any method now known or later developed in industry. The lower score 43 is positioned at the midpoint of the back panel 40. The upper score is positioned above score 43 and between score 43 and horizontal fold line 35. The scores are bent 90 degrees outwardly from the outer member 11 and inner member 49. The scores serve to pivot the outer member 11 away from the inner member 49 when the container 10 is opened. When the container 10 is in the closed position the upper and lower scores (39 and 43) introduce resistance into the container 10 between the outer member 11 and inner member 49. When the outer member 11 is closed over the inner member 49, the introduced resistance between the two members put the outer member 11 and inner member 49 in a close proximity which results in a frictional fit between the two members. The resistance introduced by the scores combined with the frictional fit resulting from the outer member 11 front panel 20, and opposing side panels (22a and 22b) encompassing the inner panel 60, and opposing side panels (62a and 62b) of the inner member 49, results in the container 10 being a self-locking container.

FIG. 3 is a similar three dimensional view of the container 10 from the right perspective with the outer member 11 in an open position to receive the collectible cards. The outer member 11 is in the top loading position, and the inner member 49 is displayed. The inner member 49 has a flat base 50, an inner front panel 60, two opposing side panels (62a and 62b), and the back panel 40, all of which are folded upwardly at a 90 degree angle along the lateral edges of the flat base 50. The flat base 50 and inner front panel 60 share a horizontal fold line 51. The flat base 50 and the back panel 40 share horizontal fold line 47. The inner member 49 has two opposing side panels (62a and 62b) which extend from the inner front panel 60. The opposing side panels (62a and 62b) fold along vertical fold lines (59 and 61) at a 90 degree angle away from the inner front panel 60. The first inner member panel 62b shares vertical fold line 61 with the inner front panel 60. The second inner member panel 62a shares vertical fold line 59 with the inner front panel 60. The inner member 49 includes securing means for securing the opposing side panels (62a and 62b) to the inner front panel 60 and back panel 40. In one embodiment the inner front panel 60 is designed with a recess 60a on the upper portion of the panel to allow for ease of loading the collectible cards. The base point of the recess 60a in the embodiment shown is approximately 2.16 inches above horizontal fold 51.

FIG. 4 is a three-dimensional view of the collectible card holder of FIG. 1 depicting the attachment locations of the securing means. For clarification of exact location, the embodiment shown in FIG. 5 may be referred to as well. In the described embodiment below, the connection mechanisms used for securing the outer and inner opposing panels consist of rectangular tabs designed to secure to the appropriate locations on the container 10, but it is envisioned that any type of connection mechanism now known or later discovered may be utilized to secure the container 10 to appropriate locations.

Referring now to the embodiment depicted in FIG. 4, the securing means on the outer member 11 and inner member 49 comprise a first and second set of connection mechanisms on each member. The first set of connection mechanisms on the outer member 11 comprise a first and second securing tab (26a and 24a) which extend from opposing side panel 22a. The first securing tab 26a extends from panel 22a and is parallel to top panel 30. Securing tab 26a shares horizontal fold line 27 with panel 26a. Securing tab 26a is substantially rectangular in form and approximately the same width as panel 22a with a slight tapering along the outer edges. Securing tab 26a is secured to the inner surface of top panel 30. Securing tab 24a extends from the side of panel 22a and shares vertical fold line 23 with panel 22a. Securing tab 24a attaches to the inner surface of back panel 40 in between horizontal fold line 35 and upper score line 39. Securing tab 24a is substantially rectangular in form and is approximately the same width as the separation between horizontal fold line 35 and upper score line 39. The second set of connection mechanisms on outer member 11 comprise a first and second securing tab (26b and 24b) which extend from opposing side panel 22b. Securing tab 26b extends from panel 22b and is parallel to top panel 30. Securing tab 26b is substantially rectangular in form and approximately the same width as panel 22b with a slight tapering along the outer edges. Securing tab 26b extends from the base of panel 22b and shares horizontal fold line 29 with panel 22b. Securing tab 26b is secured to the inner surface of top panel 30. Securing tab 24b extends from the side of panel 22b and shares vertical fold line 25 with panel 22b. Securing tab 24b attaches to the inner surface of back panel 40 in between horizontal fold line 35 and outer score line 39. Securing tab 24b is substantially rectangular in form and approximately the same width as the separation between horizontal fold line 35 and upper score line 39.

Moving to the inner member 49, the first set of connection mechanisms on the inner member 49 comprise a first and second securing tab (66a and 64a) which extend from opposing side panel 62a. Securing tab 66a is substantially rectangular in form and approximately the same width as panel 62a. Securing tab 66a extends from panel 62a parallel to top panel 50 and shares horizontal fold line 67 with panel 62a. Securing tab 66a is secured to the inner surface of base panel 50. Securing tab 64a extends from the side of panel 62a and shares vertical fold line 63 with panel 62a. Securing tab 64a is substantially rectangular in form with a slight tapering along the edges. Securing tab 64a is approximately the same height as panel 62a and attaches to the inner surface of back panel 40 in between horizontal fold line 47 and lower score line 43. The second set of connection mechanisms on inner member 49 comprise a first and second securing tab (66b and 64b) which extend from opposing side panel 62b. Securing tab 66b is of rectangular form and approximately the same width as panel 62b. Securing tab 66b extends from panel 62b parallel to top panel 50 and shares horizontal fold line 69 with panel 62b. Securing tab 66b is secured to the inner surface of top panel 50. Securing tab 64b extends from the side of panel 62b and shares vertical fold line 65 with panel 62b. Securing tab 64b is approximately the same height as panel 62b and attaches to the inner surface of back panel 40 in between horizontal fold line 47 and lower score line 43. Securing tabs 64a and 64b, overlap hinge 41, but are not secured to the hinge.

The securing tabs on the outer and inner members may be attached to the container by fusing, or other structural embodiments such as tacks, pins, or any other type of manner consistent with the function of the container. In one embodiment, ultrasonic welding is utilized as the securing means for attaching connection mechanisms to the container. While ultrasonic welding is described as one embodiment for attachment of the connection mechanisms, any means of attachment now known or later discovered may be utilized, if it serves the same function.

The collectable card holder as depicted in FIG. 1-4 demonstrates a self-locking container 10 which does not require additional components such as a hook and loop, rubber bands, or other type of securing means to keep the container 10 closed. The embodiment depicted in FIG. 1-4 is one where the collectible cards are top loaded into the container 10. The dimensions and configuration of the container 10 are such that the container may be either top loaded, where the outer member 11 opens along the vertical axis, and the cards are fed in through the top of the container, or side loaded, where the container opens along the horizontal axis, and cards are fed in from the side. In either embodiment, the dimensions and method of forming container 10 are the same. The container 10 may be sized in various widths and heights accept and receive various sizes and types of collectable cards without departing from the scope of the invention. The blank material used to create the container may be a thermoplastic polymer such as polypropylene, polystyrene, or acid-free polypropylene. Although several examples of types of material are provided, any type of material which serves the same function now known or later discovered may be utilized as the blank material. The rigid material used to form the container 10 protects the collectible cards from damage, and allows for ease of storage, loading, and access of the cards.

FIG. 5 is a view of the blank in one embodiment. This embodiment discloses the required measurements and proportions utilized to form the self-locking container. As depicted in FIG. 5, the back panel 40 on the container 10 is approximately 3.75 inches in width and approximately 2.81 inches in height. The outer member front panel 20 is approximately 3.87 inches in width, and approximately 2.77 inches in height. The inner member inner panel 60 is approximately 3.75 inches in width, and approximately 2.16 inches in height from horizontal fold 51 to the recess 60a on the inner panel 60 of inner member 49. In this embodiment, the hinge connection 41 located on the back panel 40, is created by an upper score 39 and a lower score 43 across the back panel 40. The upper score 39, and lower score 43 on the back panel 40 of the container 10 are located approximately 0.73 inches apart from with the upper score 39 located at a distance of approximately 0.71 inches below the top of the back panel 40 measuring from horizontal fold line 35.

FIGS. 6-9 depict the method of forming the container in various stages of creation. In FIG. 6, the blank 12 is shown. The shape of the blank 12 is formed by cutting the blank 12 to a foldable shape with foldable members according to predetermined dimensions, scoring the blank in two locations on a back panel to create a hinge connection, folding the blank into a container, and securing the foldable members together. Blank 12 includes five vertically aligned panels 20, 30, 40, 50, and 60 joined by horizontal fold lines 31, 35, 37, and 51 respectively. All five panels are approximately of similar width and are rectangular in shape. Panel 20 and 60 each include opposing panels (22a and 22b, and 62a and 62b) respectively. The opposing panels 22a and 22b are joined to panel 20 by vertical fold lines 19 and 21 respectively. All panels on the blank are in the same horizontal plane prior to folding the container.

Panel 20 has opposing side panels (22a and 22b). The first opposing side panel 22a has two connecting mechanisms extending outwardly from panel 22a in the form of securing tabs. The first securing tab 26a extends from panel 22a and is parallel to top panel 30. Securing tab 26a shares horizontal fold line 27 with panel 26a. Securing tab 26a is substantially rectangular in form and approximately the same width as panel 22a with a slight tapering along the outer edges. Securing tab 24a extends from the side of panel 22a and shares vertical fold line 23 with panel 22a. Securing tab 24a is substantially rectangular in form and is approximately the same width as the separation between horizontal fold line 35 and upper score line 39. The second opposing side panel 22b has two connecting mechanisms extending outwardly in two locations in the form of securing tabs. The first securing tab 26b extends from panel 22b and is parallel to top panel 30. Securing tab 26b shares horizontal fold line 29 with panel 26b. Securing tab 26b is substantially rectangular in form and approximately the same width as panel 22b with a slight tapering along the outer edges. The second securing tab 24b extends from the side of panel 22b and shares vertical fold line 25 with panel 22b. Securing tab 24b is substantially rectangular in form and is approximately the same width as the separation between horizontal fold line 35 and upper score line 39.

The connecting mechanisms may be any shape or size suitable for securing to the container. In the embodiment shown, the connection mechanisms are securing tabs, substantially rectangular in form, but it is envisioned that any design suitable for serving such securing purpose is acceptable.

Panel 30 is joined to panel 20 and 40 by horizontal fold lines 31 and 35 respectively. Panel 40 is joined to panel 30 and 50 by horizontal fold lines 35 and 47 respectively. Panel 40 contains a hinge 41 which is formed by scoring the blank 12 in two locations creating an upper score 39 and a lower score 43. Lower score 43 is located at the mid-point of panel 40. The two scores may be created by any standard method known in the arts. Panel 40 is joined to panel 50 by horizontal fold line 47. Panel 50 is joined to panel 40 and panel 60 by horizontal fold lines 47 and 67 respectively. All of the horizontal fold lines may be created by any method now known or later discovered suitable for forming the fold lines.

Panel 60 has opposing side panels (62a and 62b). The first opposing side panel 62a has two connection mechanisms which extend outwardly from panel 62a in the form of securing tabs. The first securing tab 66a extends from 62a and is parallel to base panel 50. Securing tab 66a shares horizontal fold line 67 with panel 62a. Securing tab 66a is substantially rectangular in form and approximately the same width as panel 62a. The second securing tab 64a extends from the side of panel 62a and shares vertical fold line 63 with panel 62a. Securing tab 64a is substantially rectangular in form and approximately the same height as panel 62b with a slight tapering along the outer edges.

The second opposing side panel 62b has two connection mechanisms which extend outwardly from panel 62b in the form of securing tabs. The first securing tab 66b extends panel 62b and is parallel to base panel 50. Securing tab 66b shares horizontal fold line 69 with panel 62b. Securing tab 66b is substantially rectangular in form and approximately the same width as panel 62b. The second securing tab 64b extends from the side of panel 62b and shares vertical fold line 65 with panel 62b. Securing tab 64b is substantially rectangular in form and approximately the same height as opposing panel 62b.

The connection mechanisms may be any shape or size suitable for securing to the container. In one embodiment, the connection mechanisms are rectangular tabs, but it is envisioned that any design suitable for serving such securing purpose is acceptable

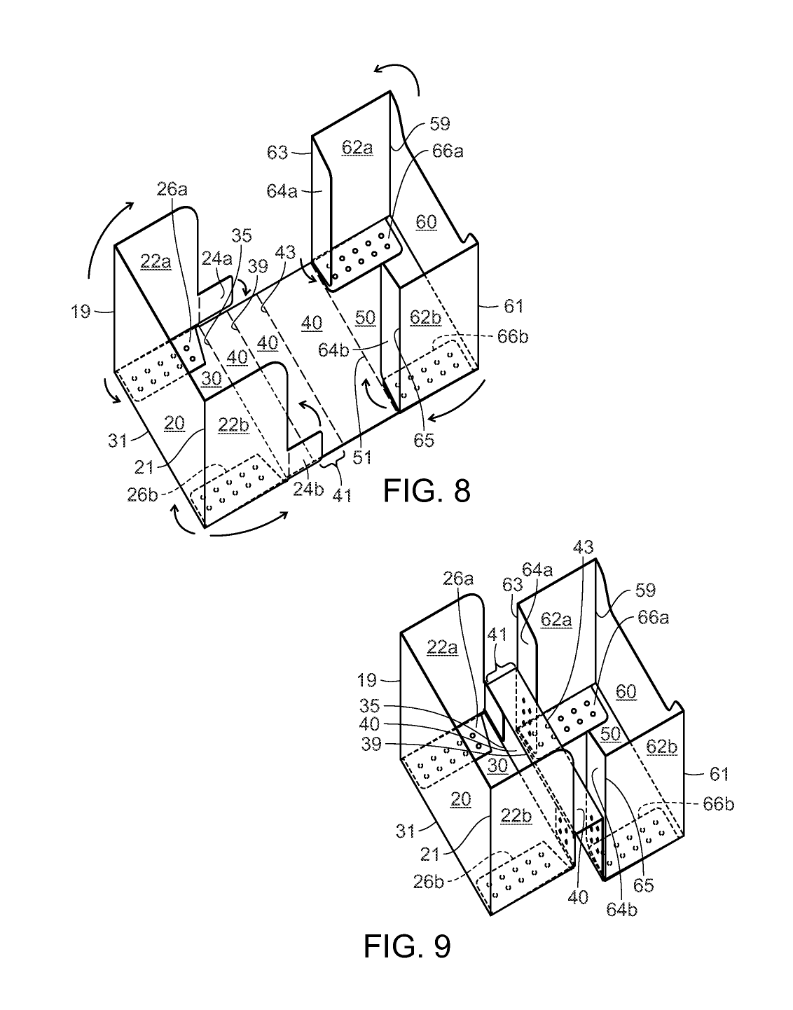

To form the container 10 from blank 12, as demonstrated in FIG. 7, the opposing side panels located on panel 20 (22a and 22b) are folded upwardly about the vertical fold lines (19 and 21) at a 90 degree angle. Similarly, the opposing side panels located on panel 60 (62a and 62b) are folded upwardly about the vertical fold lines (59 and 61) at a 90 degree angle. In FIG. 8, panel 20 is folded upwardly at a 90 degree angle about horizontal score line 31. Securing tabs 26a and 26b are folded along horizontal fold lines 27 and 29 respectively at a 90 degree angle so that the outer surface of securing tabs 26a and 26b are aligned with the inner surface of panel 30 where they are secured. Securing tabs 24a and 24b are folded inwardly at a 90 degree angle along vertical fold lines 23 and 25 respectively in preparation for securing the outer surface of the tabs to the inner surface of the back panel.

FIG. 9 depicts the final steps in creating the container 10. Panel 30 is folded about horizontal fold line 35 and pivoted toward panel 40 at a 90 degree angle. The outer surfaces of securing tabs 24a and 24b are secured to the inner surface of panel 40 between horizontal fold line 35 and upper score line 39. This step forms the outer member 49 of the container 10. Panel 50 is folded about horizontal fold line 51 and pivoted toward panel 40 at a 90 degree angle. The outer surfaces of securing tabs 64a and 64b are secured to the inner surface of panel 40 between horizontal fold line 51 and lower score line 43. This step forms the inner member 49 of the container 10. Hinge 41 is created by folding upper score line 39 and lower score line 43 at 90 degree angles downwardly, so that the outer member 11 of the container and the inner member 49 of the container rest in the open position along the same horizontal axis. The securing tabs can be secured to the container by fusing or any other method suitable for securing the members of the container. In one embodiment, ultrasonic welding is used to secure the connection mechanisms to the container 10.

To close the completed container 10, the outer member 11 is closed over the inner member 49. The creation of the hinge which consists of folding of the upper and lower scores (39 and 43) in the opposite direction of the container implements a resistance into the system so that upon closing the outer member over the inner member, the closeness in the two members caused from the resistance by the hinge keeps the container in a self-locking position.

The embodiments of the present invention have many advantages. For example, the hinge 41 of the container 10 creates a self-locking container which does not require securing mechanisms to maintain the upper member in the closed position. This self locking feature also allows for an uninterrupted view of all sides of the upper member. Artwork may be printed on all three sides without any visual interruptions to the viewer caused by seams, tears or other dividers.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term includes is used in either the detailed description or the claims, such term is intended to be inclusive in a manner similar to the term comprising as comprising is interpreted when employed as a transitional word in a claim.

What is claimed is:

1. A container for storing and protecting collectible cards formed from a single blank of material, said container being of parallelepiped shape having an outer member and a inner member,
wherein said outer member folds over said inner member to form a covered container,
said outer member comprising a top panel, a front panel, two opposing side panels, a back panel, and a means for securing said opposing side panels to said front panel and said back panel,
said front panel, said back panel, and said opposing side panels folding downward along said lateral edges of said top panel,
said inner member comprising a flat base, a inner front panel, two opposing side panels, said back panel, and a means for securing said opposing side panels to said inner front panel and said back panel
said inner front panel, said opposing side panels, and said back panel
folding upwards along the lateral edges of said flat base,
wherein said outer member and inner member share a hinge connection on said back panel, the resistance imparted from said hinge connection creates a frictional fit between said outer member encompassing said inner member which results in a self-locking container,
wherein said outer member front panel and opposing side panels of said outer member surround said inner panel and opposing side panels of said inner member, whereby allowing an uninterrupted, seamless view of the entire outer member when said outer member is closed over said inner member so that artwork may be displayed on all sides of the container.

2. The container of claim 1, wherein said securing means on said outer member and inner member comprise a first and second set of connection mechanisms on each member,
said first set of connection mechanisms on said outer member comprising a first securing tab and a second securing tab located on said first opposing side panel,
said first securing tab secures to said top panel, said second securing tab secures to said back panel,
said second set of connection mechanisms on said outer member comprise a first securing tab and a second securing tab located on said second opposing side panel, said first securing tab secures to said top panel, said second securing tab secures to said back panel,
said first set of connection mechanisms on said inner member comprising a first securing tab and a second securing tab located on said first opposing side panel,
said first securing tab secures to said base panel, said second securing tab secures to said back panel,
said second set of connection mechanisms on said inner member comprise a first securing tab and a second securing tab located on said second opposing side panel, said first securing tab secures to said base panel, said second securing tab secures to said back panel.

3. The container according to claim 1, wherein said hinge connection is created by an upper score and a lower score across said back panel of said container.

4. The container according to claim 1, wherein said back panel is approximately 3.75 inches wide and approximately 2.81 inches in height, said outer member front panel is approximately 3.87 inches wide, and approximately 2.77 inches in height, said inner panel is approximately 3.75 inches wide and approximately 2.16 inches in height at said lowest point of said inner panel, said upper and lower scores are approximately 0.73 inches apart, said upper score is located at a distance of approximately 0.71 inches below the top of said back panel.

5. The container according to claim 1, wherein said blank material is a thermoplastic polymer.

6. The container according to claim 5, wherein said thermoplastic polymer is polypropylene, polystyrene, or acid-free polypropylene.

7. The container according to claim 6, wherein said thermoplastic polymer is acid-free polypropylene.

8. The container according to claim 2 wherein said connection mechanisms on said outer opposing side panels and said inner opposing side panels are secured to said respective locations on said container by fusing.

9. The container according to claim 8, wherein said fusing of said connection mechanisms on said outer opposing side panels and said inner opposing side panels is ultrasonic welding.

10. The container according to claim 9, wherein said hinge connection is created by an upper score and a lower score across said back panel of said container.

11. The container according to claim 10, wherein said blank material is a thermoplastic polymer.

12. The container according to claim 11, wherein said thermoplastic polymer is polypropylene, polystyrene, or acid-free polypropylene.

13. The container according to claim 12, wherein said thermoplastic polymer is acid-free polypropylene.

14. The container according to claim 13, wherein said back panel is approximately 3.75 inches wide and approximately 2.81 inches in height, said outer member front panel is approximately 3.87 inches wide, and approximately 2.77 inches in height, said inner panel is approximately 3.75 inches wide and approximately 2.16 inches in height at said lowest point of said inner panel, said upper and lower scores are approximately 0.73 inches apart, said upper score is located at a distance of approximately 0.71 inches below the top of said back panel.

15. A method for creating a container for storing and protecting collectible cards, said method comprising: cutting a blank of material to a foldable shape with foldable members, scoring said blank in two locations on a back panel to create a hinge connection, folding said blank into a container, and securing said foldable members together.

16. The method for creating a container according to claim 15, wherein securing step of said foldable members to said container is performed by fusing.

17. The method for creating a container according to claim 16, wherein said fusing of said foldable members is performed by ultrasonic welding.

18. The method for creating a container according to claim 17 wherein said blank material is a thermoplastic polymer.

19. The method for creating a container according to claim 18, wherein said thermoplastic polymer is polypropylene, polystyrene, or acid free polypropylene.

20. The method for creating a container according to claim 19, wherein said thermoplastic polymer is acid free polypropylene.
